(19) United States
(12) Patent Application Publication
(10) Pub. No.: US 2013/0275161 A1
(43) Pub. Date: Oct. 17, 2013

(54) System and Method for Providing Medical Caregiver and Equipment Management Patient Care

(71) Applicants: Pradyumna Dutta, Bedford Corners, NY (US); Cornelis Conradus Adrianus Maria Van Zon, Fishkill, NY (US); Steffen Clarence Pauws, Eindhoven (NL); William Palmer Lord, Fishkill, NY (US); Juergen Te Vrugt, Aachen (DE); Alphonsus Anthonius Jozef De Lange, Overpelt (BE)

(72) Inventors: Pradyumna Dutta, Bedford Corners, NY (US); Cornelis Conradus Adrianus Maria Van Zon, Fishkill, NY (US); Steffen Clarence Pauws, Eindhoven (NL); William Palmer Lord, Fishkill, NY (US); Juergen Te Vrugt, Aachen (DE); Alphonsus Anthonius Jozef De Lange, Overpelt (BE)

(73) Assignee: KONINKLIJKE PHILIPS ELECTRONICS N.V., EINDHOVEN (NL)

(21) Appl. No.: 13/995,504

(22) PCT Filed: Dec. 5, 2011
(86) PCT No.: PCT/IB2011/055460

§ 371 Date: Jun. 19, 2013

Related U.S. Application Data
(60) Provisional application No. 61/424,859, filed on Dec. 20, 2010.

(51) Int. Cl. G06F 19/00

(52) U.S. Cl. CPC G06F 19/324
USPC 705/3

(57) ABSTRACT

An update message from a first group of one or more clinical devices (802) is received over a communications network (504). The update message includes patient data and identifies a computer interpretable guideline (CIG) instance corresponding to a patient of the patient data. The CIG instance is updated (804) using the patient data and one or more CIG recommendations are determined (806) based on the updated CIG instance. The CIG recommendations are communicated (808) to a second group of one or more clinical devices over the communications network (504). Also disclosed, a narrative guideline is received from a guideline publisher and/or business entity (102) over a communications network (104). The narrative guideline is transformed to a computer represented guideline (CRG) abstractly representing the narrative guideline on the basis of usage. The translation includes linking text fragments in the narrative guideline to instantiated language constructs.

The present application relates generally to clinical guidelines. It finds particular application in conjunction with distribution of clinical guidelines to a point of care, and will be described with particular reference thereto. However, it is to be understood that it also finds application in other usage scenarios, and is not necessarily limited to the aforementioned application.

Clinical guidelines are recommendations for caring for patients. Clinical guidelines are typically independent of any specific hospital, area, medical group, or the like. Further, clinical guidelines are typically published by expert bodies such as the American Heart Association, the American Diabetes Association, the Institute for Clinical Systems Improvement, and the like.

A significant trend in healthcare has been an increasing expectation of healthcare providers to adhere to clinical guidelines. Clinical guidelines are increasingly viewed as sources of “best-practice” standards of care. Further, adherence to the recommendations of clinical guidelines has been shown to reduce costs and improve outcomes. Accordingly, there is a growing need for computer-based clinical decision support (CDS) systems that support care providers in adhering to clinical guidelines.

A challenge with incorporating clinical guidelines within CDS systems is that clinical guidelines are usually in a narrative format, and not specified in a format that can be processed by a computer. Therefore, clinical guidelines often need to be translated into a procedural and specific format that can be processed by a computer, hereafter referred to as a Computer-Interpretable Guideline (CIG).

Translating a clinical guideline into a CIG is difficult, resource-intensive, and requires specialized medical knowledge. Typically, knowledge engineers or clinical specialists provide this specialized medical knowledge. Part of the difficulty is that a CIG requires information local to a hospital, an area, a medical group, or the like, which is not readily available for certain medical institutions.

Another challenge with incorporating clinical guidelines within CDS systems is that clinical guidelines have regular revisions because of new clinical insights and/or improved treatment methods. If a clinical guideline is revised, the creation effort of a CIG and the connections between the original clinical guideline and formal CIG are lost. For instance, it is difficult to find what changes in the formal CIG are required to implement the changes in the clinical guideline.

Beyond the challenges with incorporating clinical guidelines within CDS systems, challenges arise in distributing CIGs to clinicians at a point-of-care. CIGs are typically provided to clinicians by way of CDS recommendations. Several studies have shown that in order for CDS recommendations to be effective, the CDS recommendations have to be provided to the user at the point-of-care.

A challenge with providing CDS recommendations at the point-of-care stems from the computation and data resources of the device at the point of care. Patient data outside of what is collected by the device is typically not available to it. Further, even if networked devices have access to data from other devices via, for example, an electronic medical record (EMR), patient data that has not been collected by a device is not available. Moreover, the device may not contain the computing resources to execute a CIG and store the CIG or the relevant patient data. Even more, CIGs currently offered are not scalable across devices and platforms.

Another challenge stems from the large diversity of medical devices at the point-of-care, since various multi-vendor clinical devices deploy different (software) technologies and proprietary protocols to exchange data between each other. Yet another challenge arises because clinical departments have their own requirements in various clinical specialties, work flows, and organizational processes, with local or regional variants in which healthcare providers cooperate in care processes that run in conjunction.

The present application provides a new and improved system and method for distributing clinical guidelines to a point of care, which overcomes the above-referenced problems and others.

In accordance with one aspect, a method for centrally executing computer interpretable guidelines (CIGs) is provided. An update message from a first group of one or more clinical devices is received over a communications network, where the update message includes patient data and/or end user input and identifies a CIG instance corresponding to a patient associated with the patient data. A CIG instance is the data that must be persisted to allow execution of a particular CIG to continue when re-loaded. The CIG instance is updated using the patient data and/or end user input and one or more CIG recommendations are determined based on the updated CIG instance. The CIG recommendations are communicated to a second group of one or more clinical devices over the communications network.

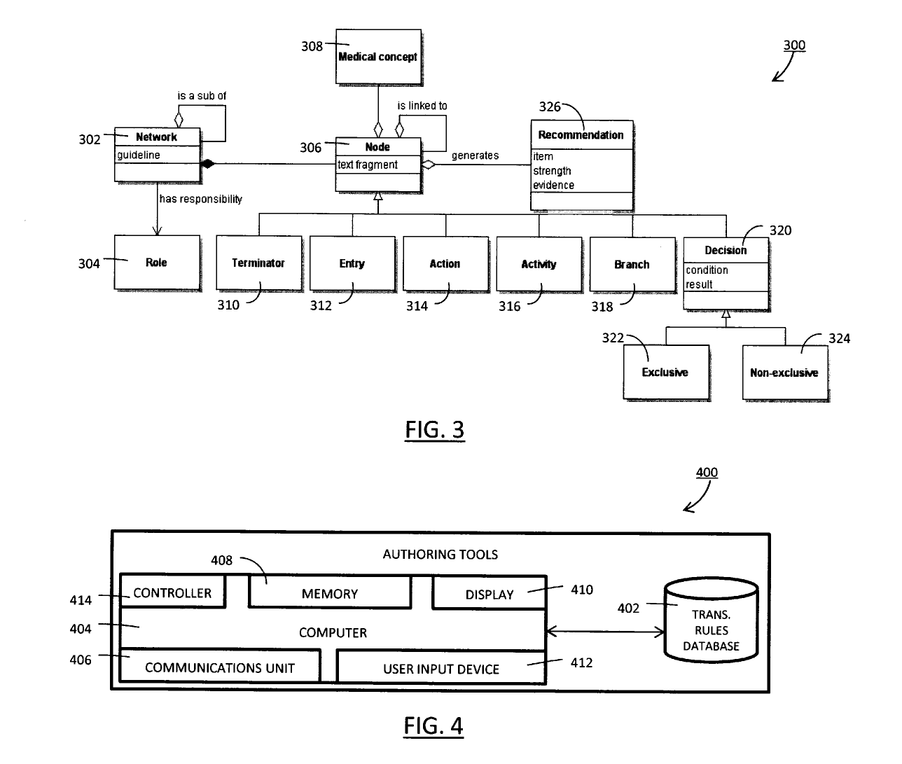

According to another aspect, a method of electronically distributing clinical guidelines is provided. A narrative guideline is received from a guideline publisher and/or business entity over a communications network. The narrative guideline is transformed to a computer represented guideline (CRG) abstractly representing the narrative guideline on the basis of usage. The translation includes linking text fragments in the narrative guideline to instantiated language constructs, such as the data model of FIG. 3.

According to another aspect, a system for centrally executing computer interpretable guidelines (CIGs) is provided. The system includes a first group of one or more clinical devices, a second group of one or more clinical devices, and a clinical decision support system. The clinical decision support system receives an update message from the first group of clinical device(s) over a communications network, where the update message includes patient data and identifies a CIG instance corresponding to a patient associated with the patient data. Thereafter, the CIG instance is updated using the patient data and one or more CIG recommendations are determined based on the updated CIG instance. The CIG recommendations are communicated to the second group of clinical device(s) over the communications network.

One advantage of the present systems and methods resides in the ability to deliver CDS recommendations at the point-of-care.

Another advantage resides in the ability to provide CDS recommendations based on data collected from a plurality of clinical devices.

Another advantage resides in the ability to disconnect dependencies between CDS recommendations and physical resources of devices at the point-of-care.

Another advantage resides in the ability to provide CDS recommendations across devices and platforms.

Another advantage resides in the ability to maximize re-use of previous work when creating CIGs.

Another advantage resides in the ability to efficiently translate narrative guidelines to CIGs.

Another advantage resides in the ability to electronically distribute new and/or updated guidelines.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

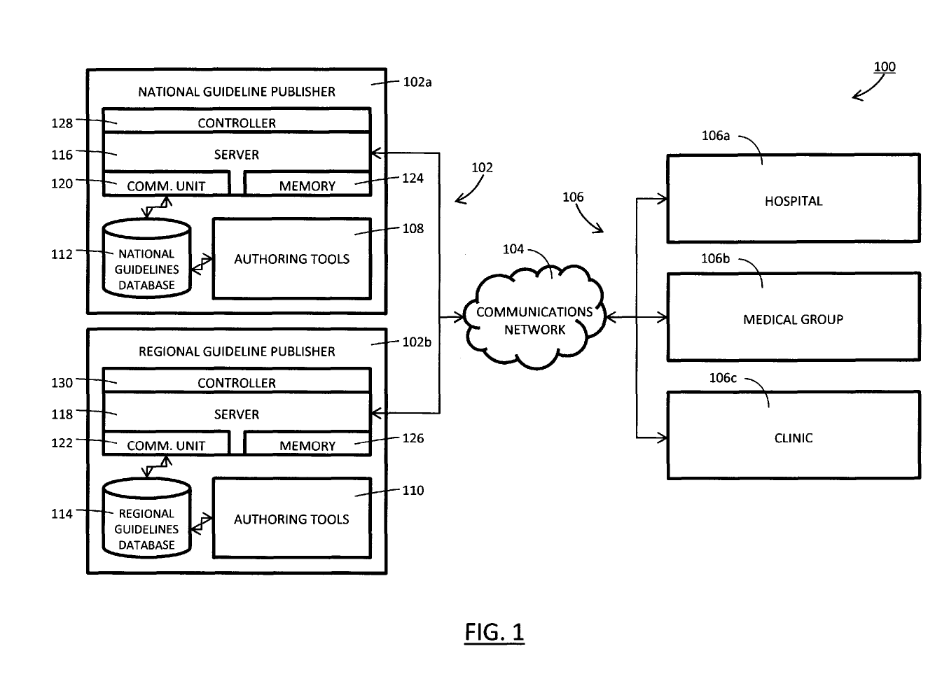

FIG. 1 is a block diagram of a clinical guideline distribution system according to aspects of the present disclosure;

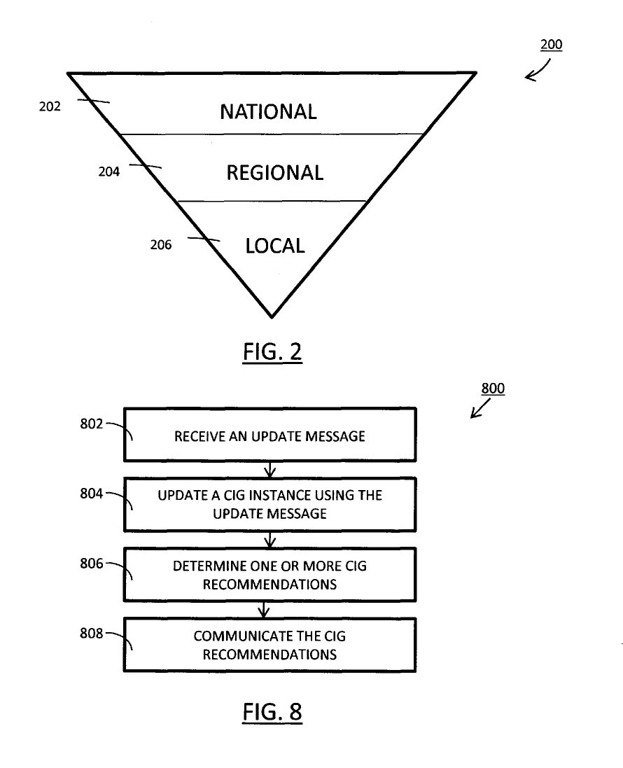

FIG. 2 is a pyramid chart illustrating the hierarchical relationship between different abstraction levels of CRGs according to aspects of the present disclosure;

FIG. 3 is a class diagram illustrating a data model of a CRG according to aspects of the present disclosure;

FIG. 4 is a block diagram of authoring tools according to aspects of the present disclosure;

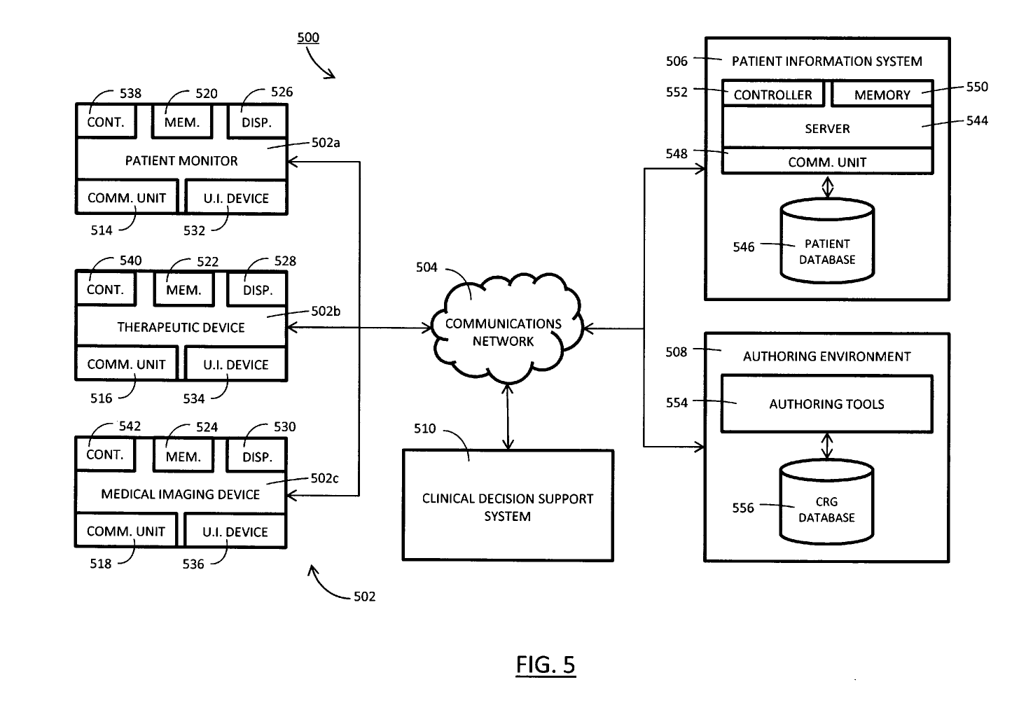

FIG. 5 is a block diagram of an institution according to aspects of the present disclosure;

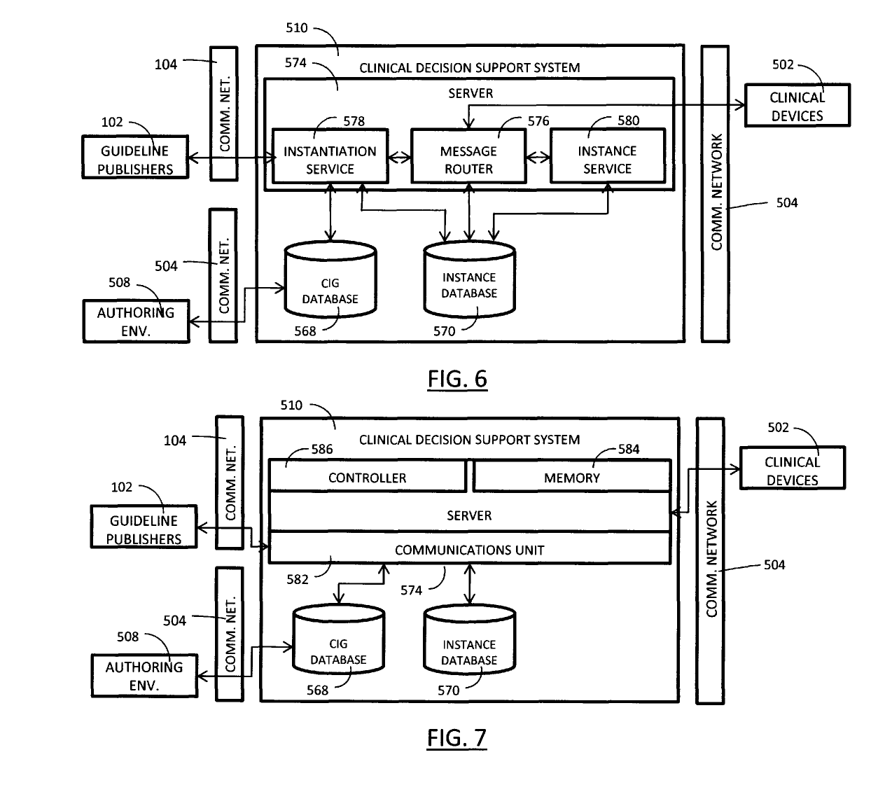

FIG. 6 is a functional view of a clinical decision support system according to aspects of the present disclosure;

FIG. 7 is a structural view of a clinical decision support system according to aspects of the present disclosure;

FIG. 8 is a method for centrally executing computer interpretable guidelines (CIGs) according to aspects of the present disclosure; and,

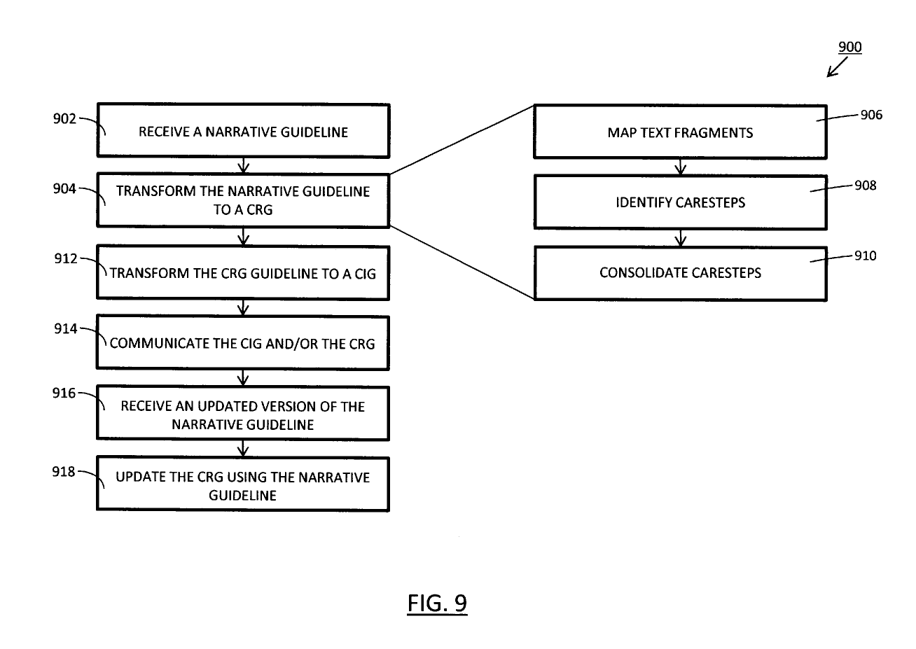

FIG. 9 is a method of electronically distributing clinical guidelines according to aspects of the present disclosure.

With reference to FIG. 1, in one embodiment, a clinical guideline distribution system 100 includes one or more guideline publishers and/or business entities 102, a communications network 104, one or more medical institutions 106, and the like. A goal of the distribution system 100 is to facilitate efficient dissemination of new and/or updated guidelines to the medical institution(s) 106.

The guideline publisher(s) and/or business entity(ies) 102 each publish new and/or updated guidelines. The guidelines are suitably published to the communications network 104 via, for example, a web server. However, it is also contemplated that the guidelines are published through the dissemination of physical mediums carrying the guidelines. These physical mediums include, for example, one or more of a printed medium, a non-transient computer readable medium, and the like. The guidelines include one or more of narrative guidelines, computer represented guidelines (CRGs), computer-interpretable guidelines (CIGs), and the like.

The narrative guidelines correspond to human readable guidelines typically published in publications, such as medical journals, on websites, such in an html format, or the like. The narrative guidelines are presently the preferred type of guideline for wide spread dissemination and they are not computer interpretable.

The CRGs correspond to computer represented guidelines (i.e., guidelines in a computer representation language) intermediate a human readable form and a computer interpretable form. CRGs are not interpretable (i.e., executable) by computers due to ambiguity in clinical goals, variations in resources (e.g., imaging modalities available), variations in case-mix (e.g., what proportion of patients are newly diagnosed versus very sick), and other local constraints. In some embodiments, the syntax and structure of the CRGs can be represented as a data model, as discussed below in connection with FIG. 3.

The CRGs employ one or more levels of abstraction not defined by implementation and conceptual description, but by usage, to improve the efficiency by which they are disseminated. To illustrate, if a CRG is slated for national or international distribution, the CRG is suitably generated so aspects of the CRG that are highly variable on a national scale are left open ended and/or incomplete. CRGs are typically abstracted at the level of one or more of medical groups, collections of hospitals, hospitals, and the like. However, abstraction at the application level is contemplated.

The CRGs are typically derived from one or more of narrative guidelines, other CRGs, and the like. In embodiments in which the CRGs are derived from narrative guidelines, the narrative guidelines are translated to the computer represented guideline format and certain aspects thereof are left open ended and/or incomplete based on the usage of the CRGs. In embodiments in which the CRGs are derived from other CRGs, aspects of the other CRGs are narrowed and/or broadened based on the usage of the new CRGs. To illustrate, suppose a regional CRG is derived from a national CRG by narrowing aspects of the national CRG that were left open ended and/or incomplete, due to the variability of these aspects on a national scale, when these aspects are no longer variable at the regional level. As should be appreciated, even if a CRG is generated from another CRG, it will generally have an associated narrative guideline.

The CIGs correspond to computer interpretable guidelines that can be processed by a digital processing device, such as a computer. CIGs are typically generated from CRGs by incorporating localized clinical knowledge into the CRGs. For example, in certain embodiments, a care step of a CRG provides a listing of potential courses of action, thereby leaving it to the end user to choose the course of action. When authoring a CIG, considerations include, but are not limited to, availability of resources, clinical expertise, institutional policy, choice of clinical procedures, treatments, and the like.

The guideline publisher(s) and/or business entity(ies) 102 are typically guideline committees, national or otherwise. However, in certain embodiments, the guide publisher(s) and/or business entity(ies) 102 additionally or alternatively are one or more of academic institutions, business entities (e.g., PHILIPS) providing guidelines as a service, one or more of the medical institution(s) 106, and the like. For example, an academic institution shares its CIGs or CRGs. As another example, a business entity sells CIGs and/or CRGs as a paid service to the medical institution(s) 106. Further, in certain embodiments, the guideline publisher(s) and/or business entity(ies) 102 share guidelines amongst themselves. For example, a business entity selling CIGs and/or CRGs receives a narrative guideline from a guideline committee. Each of the guideline publisher(s) and/or business entity(ies) 102 suitably includes one or more of a server, such as a web server, a guidelines database, authoring tools, and the like.

As illustrated, the guideline publisher(s) and/or business entity(ies) 102 includes a national guideline publisher 102a and a regional guideline publisher 102b. The national guideline publisher 102a and the regional guideline publisher 102b publish one or more of narrative guides, CRGs, CIGs, and the like. Suitably, the CRGs of the national guideline publisher 102a are generated at an abstraction level suitable for national usage, and, suitably, the CRGs of the regional guideline publisher 102b are generated at an abstraction level suitable for regional usage. In some embodiments, the regional guideline publisher 102b publishes CRGs derived from guidelines published by the national guideline publisher 102a.

Authoring tools 108, 110 facilitate modification and/or creation of guidelines, CRGs or otherwise, in databases 112, 114 of the guideline publisher(s) and/or business entity(ies) 102 and can be part of the guideline publisher(s) and/or business entity(ies) 102 or independent third parties. For detail pertaining to the authoring tools 108, 110, attention is directed to the discussion of FIG. 4, below. The databases 112, 114 store the guidelines published by the guideline publisher(s) and/or business entity(ies) 102. Servers 116, 118 of the guideline publisher(s) and/or business entity(ies) 102 facilitate the distribution of the guidelines in the databases 112, 114 over the communications network 104. It is contemplated that the servers 116, 118 are one or more of HTTP(S) servers, FTP servers, and the like.

Communications units 120, 122 of the servers 116, 118 facilitate communication between the servers 116, 118 and external devices, such as the medical institution(s) 106. The communications units 120, 122 further facilitate communication with the databases 112, 114. Memories 124, 126 of the servers 116, 118 store executable instructions for performing one of more of the functions associated with the servers 116, 118. Controllers 128, 130 of the servers 116, 118 execute instructions stored on the memories 124, 126 to carry out the functions associated with the servers 116, 118.

The communication network 104 allows communication between components connected thereto and is suitable for the transfer of guidelines. Suitably, the communications network 104 is the Internet. However, it is contemplated that the communications network 104 is one or more of a local area network, a wide area network, a wireless network, a wired network, a cellular network, a data bus, such as USB and I2C, and the like.

The medical institution(s) 106 receive guidelines, narrative or otherwise, from the guideline publisher(s) and/or business entity(ies) 102. The received guidelines are typically updates to local guidelines, but, in certain embodiments, are new guidelines. The updates are received using a push methodology, a pull methodology, or the like. Using the pull methodology, the medical institution(s) 106 receive guidelines from the guideline publisher(s) and/or business entity(ies) 102 by pulling the guidelines from the guideline publisher(s) and/or business entity(ies) 102. For example, one of the medical institution(s) 106 receives guidelines from one of the guideline publisher(s) and/or business entity(ies) 102 in response to a request. Using the push methodology, the guideline publisher(s) and/or business entity(ies) 102 push guidelines to the medical institution(s) 106. For example, one of the medical institution(s) 106 subscribes with one of the guideline publisher(s) and/or business entity(ies) 102 to have the guideline publisher automatically send new and/or updated guidelines to the medical institution.

Upon receipt of a new guideline, the receiving one of the medical institution(s) 106 typically adds the new guideline to a collection of local guidelines and/or customizes the new guideline. If the new guideline is a narrative guideline, the medical institution suitably converts the new guideline to a CRG and customizes the generated CRG. If the new guideline is a CRG, the medical institution suitably customizes the CRG. If the new guideline is a CIG, the medical institution suitably uses the CIG as is, but it is contemplated that the medical institution customizes the CIG. In each case, the authoring tools, described in FIG. 4, are suitably employed. Customization typically includes a review of the received guideline by a knowledge engineer (e.g., a doctor) and/or a committee of the medical institution. This review process allows determination of the customizations that need to be made to integrate local workflows, protocols, and the like to the new guideline.

Upon receipt of an updated guideline, the receiving one of the medical institution(s) 106 typically updates one or more corresponding local guidelines in accordance with the updated guideline. Suitably, the authoring tools are employed to update the local guideline(s). As discussed below, the authoring tools allow a comparison of the updated guideline with the local guideline(s) so as to highlight differences, whereby updating involves merging identified changes. Similar to adding new guidelines, updating typically includes a review of the updated guideline by a knowledge engineer and/or a committee of the medical institution. This review process allows determination of the updates to incorporate into the local guideline(s), where it is contemplated that this determination considers one or more of local workflows, protocols, and the like.

The medical institution(s) 106 additionally, or alternatively, in certain embodiments, share local guidelines with each other and/or the guideline publishers and/or business entity(ies) 102. In such embodiments, the one or more sharing ones of the medical institution(s) 106 are members of the guideline publisher(s) and/or business entity(ies) 102. This is important because, while certain academic and research hospitals have well developed local guidelines or protocols, other medical institutions may not, thereby making it difficult for them to generate CIGs.

With reference to FIG. 2, a pyramid chart 200 illustrating a hierarchical relationship between different abstraction levels of CRGs according to aspects of the present disclosure is provided. The pyramid chart 200 is to be understood as merely illustrative and in no way limiting of the usage based abstraction levels that can be employed by CRGs. The chart includes a national level 202, a regional level 204, and a local level 206.

CRGs that represent guidelines at the national level 202 leave open ended or incomplete those aspects that vary within a national level. These CRGs are suitably provided to a national audience by, for example, the national guideline publisher 102a. CRGs that represent guidelines at the regional level 204 leave open ended or incomplete those aspects that vary within a regional level. These CRGs are suitably provided to a regional audience by, for example, the regional guideline publisher 102b. CRGs that represent guidelines at the local level 206 leave open ended or incomplete those aspects that vary on a local level. For example, those aspects that vary within one of the medical institutions 106 of FIG. 1 are left open ended. The CRGs that represent guidelines at the local level 206 are suitably employed to generate computer interpretable guidelines (CIGs).

With reference to FIG. 3, a class diagram 300 illustrative of a data model suitably employed by a CRG is provided. The model is formed from a hierarchy of interconnected nodes that represent the care flow in the guideline as a network of clinical actions and decisions. A network, such as a network 302, refers to a particular guideline and, in certain embodiments, comprises several smaller networks (sub networks) to realize the hierarchical structure.

A role and responsibility, such as a role and responsibility 304, is associated with each network. For example, in certain embodiments, a registered nurse (RN) or clinician is assigned a role and responsibility. Further, each network consists of nodes, such as a node 306. Each node generally refers to a text fragment in an associated narrative guideline and is associated with concepts from a standardized medical ontology, such as a medical concept 308. Nodes are interconnected to form the network and the care flow. It is contemplated that a link connecting a parent node and a child node signifies one or more of the child node must follow the parent node, the child node is recommended to follow the parent node, the child node usually follows the parent node, and the like. In certain embodiments, nodes are specialized into other node types. Node types include one or more of a terminator, such as a terminator 310, an entry, such as an entry 312, an action, such as an action 314, an activity, such as an activity 316, a branch, such as a branch 318, a decision, such as decision 320, and the like.

A terminator represents the starting and end node of the network. An entry provides a means to assign a patient to a care step somewhere in the guideline. An action represents an instantaneous care step. An activity represents a long-running care step. A branch allows the initiation of concurrent care steps. A decision provides the means to model a clinical decision. Examples include one or more of mutual exclusion (i.e., a strict if-then), such as an exclusive decision 322, non-exclusion in which multiple options can be pursued, such as a non-exclusive decision 324, and the like.

Every node can generate a set of recommendations, such as a recommendation 326. A recommendation comprises an item (i.e., the recommendation itself) and its level of strength and evidence as reported in the guideline. It also contains a justification for the recommendation based on reported studies.

The data model leaves room for constructions that cannot be interpreted or executed. For example, textual descriptions of decisions or recommendations can still exist in a CRG. It can contain various options for treatment. As another example, a CRG does not need to specify a strict ordering of treatment steps, since, as noted above, links connecting a parent node and a child node do not necessarily require the child node to follow the parent node. In the conversion process from a CRG to a CIG, in which constraints imposed on the model are resolved, decisions and recommendations can be further specified and localized. Also, strict ordering of care steps is enforced and treatment options can be chosen and/or elaborated on.

To illustrate, according to the European Society of Cardiology (ESC) guidelines for Congestive Heart Failure (CHF), one of the criteria for a CHF diagnosis is “objective evidence of cardiac dysfunction”. This can be directly copied in a CRG decision node, and when it comes time to generate a CIG, it will be quantified as, in an example of left ventricle ejection fraction, “LVEF<40%” with the explanation “determine LVEF by echocardiography”.

With reference to FIG. 4, an embodiment of authoring tools 400, such as the authoring tools 108, 110 of guideline publisher(s) and/or business entity(ies) 102 of FIG. 1, is provided. The authoring tools 400 facilitate the generation and/or modification of CRGs. For example, in certain embodiments, the authoring tools 400 facilitate the transformation of a narrative guideline into a CRG and/or the modification of a CRG from one abstraction level to another abstraction level. Additionally or alternatively, the authoring tools 400 facilitate the generation and/or modification of CIGs.

The authoring tools 400 allow a knowledge engineer, such as a doctor trained in authoring CRGs, to define a CRG according to the computer represented guideline format and/or modify a CRG according to the computer represented guideline format. For example, in embodiments employing CRGs represented according to the data model of FIG. 3, the authoring tools 400 allow the individual to define the nodes, the networks, the sub-networks, the relations therebetween, and the like.

Additionally or alternatively, the authoring tools 400 allow the knowledge engineer to create a CRG on the basis of a narrative guideline. In certain embodiments, this is carried out by allowing the knowledge engineer to link text fragments in the narrative guideline to instantiated language constructs of the computer represented guideline format. The instantiated language constructs are linked manually, semi-automatically, or automatically. In embodiments employing the data model of FIG. 3, the language constructs include, for example, nodes and networks. Suitably, these links are preserved in the complete authoring process and can be used for documentation (comment generation) and quick reference in later revisions. For example, the links are preserved to allow local CRGs to be quickly revised and/or updated when new narrative guidelines become available.

To create a CRG employing the data model of FIG. 3, the text fragments are suitably analyzed on their linguistic form using a linguistic processing pipeline comprising one or more of sentence splitting, tokenizing, stemming, tagging, and the like. This analysis results in mapping text fragments to a set of concepts in a medical ontology (e.g., systematized nomenclature of medicine—clinical terms (SNOMED CT)). Further, the control flow of care steps (e.g., the various clinical decisions on diagnosis and treatment), the recommendations, the data flow, the resources, the responsibilities, and the various temporal relations between these care steps are identified and consolidated. Consolidation is done by instantiating language constructs of a CRG. Therefore, in these embodiments, the authoring tools 400 transform textual description in the guideline into instances of the model.

While CRGs are suitably as complete as possible, CRGs allow for incomplete or open expressions (e.g., expressions in a natural language) so as to facilitate abstraction on the basis of usage. Therefore, the CRG is typically not executable. For instance, a CRG can still have decision criteria in natural language, undefined threshold values for tests and examinations, or several options for treatment that are left open for clinical expertise.

Additionally or alternatively, the authoring tools 400 allow the knowledge engineer to compare updated guidelines, CRGs or narrative guidelines, against local CRGs to determine differences therebetween. To facilitate the comparison of a CRG with an updated guideline, links between the CRG and the updated guideline are preserved in the CRG. Hence, text fragments from the updated guideline can be mapped to instantiated objects of the CRG. In certain embodiments, links are maintained by documenting instantiated objects in a CRG with text fragments.

Additionally or alternatively, the authoring tools 400 allow a knowledge engineer, such as a doctor, to define the content of a CIG and/or modify the computer represented guideline format of a CIG. In certain embodiments, a CIG is modeled using a variant of the model employed by a CRG, such as the data model of FIG. 3, though the model typically has extensions due to the more verbose syntax of a CRG and constraints to enforce completeness, consistency and resolution of ambiguities in the specification. The syntax can incorporate a full-fledged, sound and consistent expression language for decision criteria which enables access to a patient data model in a standardized way. In such embodiments, the authoring tools 400 allow the individual to define and/or modify the nodes, the networks, the sub-networks, the relations therebetween, and the like of a CIG.

Additionally or alternatively, the authoring tools 400 allow the knowledge engineer to create the CIG on the basis of a CRG. To create a CIG based on a CRG, the authoring tools 400 create a CIG from an existing instantiation of a CRG model by means of vertical transformation, which is a well-known method in the field of Model-Driven Development (MDD). In this field, models are used to facilitate abstraction and automated development.

A transformation is the automatic generation of a target model (e.g., a CIG) from a source model (e.g., a CRG), according to a transformation definition. A transformation definition is a set of transformation rules that together describe how a model in the source language can be transformed into a model in the target language. A transformation rule is a description of how one or more constructs in the source language can be transformed into one or more constructs in the target language.

In order to transform models, these models need to be expressed in some modeling language (e.g., class diagrams) whose syntax and semantics itself is expressed in a meta-model. However, this transformation is not a fully automatic process, but a step-by-step interactive one. A knowledge engineer and/or a local expert are required to solve constraints imposed on the CIG model.

Aspects that need to be filled in by the knowledge engineer and/or the local expert include one or more of threshold values for examinations and/or tests; definitions of locally agreed care steps in well-defined situations (i.e., care protocols); installation of patient eligibility criteria for randomized clinical trials or other clinical studies; choice of treatment based on availability of resources, staff experience and institutional policy; elaboration on treatment steps to achieve or maintain particular clinical targets; local or regional threats/prevalence on contraindications, diseases, allergies or hospital acquired infections; and the like.

Additionally or alternatively, authoring tools 400 allow the knowledge engineer to compare updated CRGs against CIGs to determine differences therebetween. Suitably, CIGs maintain links to corresponding CRGs, so a knowledge engineer can find parts of CIGs that need to be changed when corresponding CRGs are updated. In certain embodiments, CRGs and CIGs are documented with text fragments taken from the original narrative guideline, where these text fragments are used to link the CRGs and the CIGs.

Typically, the authoring tools 400 include one of more of a database 402, a computer 404, and the like. The database 402 suitably stores the transformation rules needed to transform a CRG to a CIG. The computer 404 carries out the functionality of the authoring tools 400 and suitably embodies the authoring tools 400. For example, the computer 400 allows a user thereof to update and/or modify CIGs and/or CRGs.

A communications unit 406 of the computer 404 facilitates communication with external systems and/or databases, such as the database 402. A memory 408 of the computer 404 stores executable instructions for performing one of more of the functions associated with the authoring tools. A display 410 of the computer 404 allows the computer 404 to display a user interface allowing a user, such as the knowledge engineer, to interact with the authoring tools 400. A user input device 412 of the computer 404 allows the user to interact with the user interface. A controller 414 of the computer 404 executes instructions stored on the memory 408 to carry out the functions associated with authoring tools 400.

With reference to FIG. 5, a block diagram of a subset of the computer infrastructure of one 500 of the institution(s) 106 of FIG. 1, such as the hospital 106a, is illustrated. The institution 500 includes one or more clinical devices 502, a communications network 504, a patient information system 506, an authoring environment 508, a clinical decision support system 510, and the like.

The clinical device(s) 502 provide(s) data to and/or receive recommendations from the clinical decision support system 510. The clinical device(s) 502 include(s) any devices that are used for a medical purpose, even a clinician's personal device, such as an iPhone, if it is used for a medical purpose. Examples of the clinical device(s) 502 include one or more of end user terminals, peripheral clinical devices, patient monitors, devices at a patient bed or the clinician desktop, nursing stations, mobile communications devices, hospital-wide systems, workstations, displays, and the like, at various physical locations in the institution 500. In certain embodiments, the CDSS 510 is employed as a clinical device. In other words, it is contemplated that the CDSS 510 includes a computer with a display and user input device, such as a keyboard and/or mouse, employed to enter and/or review data.

Each of the clinical device(s) 502 is associated with a patient directly or indirectly. For example, a patient monitor is attached to a patient and/or a workstation is configured to monitor a patient. In certain embodiments, a clinical device is indirectly associated with a patient if a clinician is directly associated with a patient and the clinical device is directly associated with the patient. End users (e.g., registered nurses and/or physicians) of the clinical device(s) 502 suitably associate patient IDs (e.g., name, electronic medical record identification (EMR ID), or date of birth (DOB)) with the clinical device(s) 502. However, it also contemplated that the clinical device(s) 502 determine the patient IDs automatically by, for example, RFID tags associated with the patients. Further, each of the clinical device(s) 502 includes a device ID, such as an IP address, and is associated with a CIG instance known by a unique CIG instance ID. End users suitably associate the CIG instance ID.

In certain embodiments, a distinction is made between ones of the clinical device(s) 502 providing data to the clinical decision support system 510 and ones of the clinical device(s) 502 receiving recommendations from the clinical decision support system 510. It is contemplated that one or more of the clinical device(s) 502 belong to both groups.

The clinical device(s) providing data to the clinical decision support system 510 provide update messages thereto. An update message suitably includes updated patient data (e.g., user input, patient data, lab results, order entry) and identifies one or more of a patient ID, a CIG ID, a device ID, a CIG instance ID, and the like. The update message is sent directly (as shown) or indirectly via the patient information system 508 to the clinical decision support system 510. As discussed below, the update message is employed by the clinical decision support system 510 to update an instance of a CIG.

In certain embodiments, before providing data to the clinical decision support system 510, the clinical device(s) request a CIG instance via instantiation messages. An instantiation message suitably includes a patient ID, a CIG ID, a device ID, and the like. As discussed below, instantiation causes the clinical decision support system 510 to create an instance of the CIG specified by the CIG ID, if none exists for the combination of the patient ID and the device ID, and return a CIG instance ID corresponding to the instance. This CIG instance ID is suitably distributed to other components of the institution 500, optionally via the patient information system 506 or the CDSS 510, so these components may uniquely identify the instance. This instantiation is suitably performed on indication from the end users.

The clinical device(s) receiving recommendations from the clinical decision support system 510 receive a recommendation message from the clinical decision support system 510 when an associated CIG instance is updated by, for example, data in an update message. The recommendation message identifies recommendations for an associated clinician and/or actions performed by the clinical decision support system 510. To receive the recommendation messages, the clinical device(s) suitably register with the clinical decision support system 510. For example, on indication from the end user, one of the clinical devices sends a registration message containing one or more of a patient ID, a CIG ID, a device ID, a CIG instance ID, or the like to the clinical decision support system 510. It is contemplated that the CIG instance ID is acquired from another system of the institution 500, such as the patient information system 506. Alternatively, it is contemplated that the CIG instance ID is acquired by searching for CIG instance IDs of interest on the communications network 504 by exchanging a discovery message containing, for example, a patient ID and a CIG ID with another component of the institution 500, such as the CDSS 510, to acquire a corresponding and available CIG instance ID.

As illustrated, the clinical device(s) 502 include a patient monitor 502a, a therapeutic device 502b, and a medical imaging device 502c. Communications units 514, 516, 518 of the clinical device(s) 502 facilitate communication with external systems and/or databases, such as the clinical decision support system 510, via the communications network 504. Memories 520, 522, 524 of the clinical device(s) 502 store executable instructions for performing one of more of the functions associated with the clinical device(s) 502. Displays 526, 528, 530 of the clinical device(s) 502 allow the clinical device(s) 502 to display data and/or messages for the benefit of corresponding users. User input devices 532, 534, 536 of the clinical device(s) 502 allow corresponding users of the clinical device(s) 502 to interact with the clinical device(s) 502 and/or respond to messages displayed on the displays 526, 528, 530. Controllers 538, 540, 542 of the clinical device(s) 502 execute instructions stored on the memories 520, 522, 524 to carry out the functions associated with the clinical device(s) 502.

The communications network 504 allows communication between components, such as the clinical decision support system 510 and the clinical device(s) 502, connected thereto and is suitable for the transfer of digital data between the components. Suitably, the communications network 504 is a local area network. However, it is contemplated that the communications network 504 is one or more of the Internet, a wide area network, a wireless network, a wired network, a cellular network, a data bus, such as USB and I2C, and the like.

The patient information system server 506 acts as a central repository of electronic medical records (EMRs) for patients. Patient data from the clinical device(s) 502 and other devices generating patient information are suitably stored in the patient information system 508. In some instances, patient data are received directly from the source of the patient data, and, in other instances, patient data are received indirectly from the source of the patient data. For example, patient data generated by one of the clinical device(s) 502 are received indirectly from the clinical decision support system 510.

Typically, the patient information system 506 includes one of more of a server 544, a database 546, and the like. The database 546 suitably stores EMRs for patients of the institution 500. A patient ID, such as one or more of name, EMR ID, DOB, and the like, for example, indexes the records. The server 544 allows components of the institution 500 to access to the EMRs via the communications network 504. A communications unit 548 of the server 544 facilitates communication between the server 544 and external devices, such as the clinical device(s) 502. The communications unit 548 further facilitates communication with the database 546 of the patient information system 508. A memory 550 of the server 544 stores executable instructions for performing one of more of the functions associated with the server 544. A controller 552 of the server 544 executes instructions stored on the memory 550 to carry out the functions associated with the server 544.

The authoring environment 508 facilitates the generation and/or modification of local CRGs and/or CIGs using authoring tools 554 during “development time”. Development time corresponds to the period of time when CRGs and/or CIGs are being modified and/or generated and is to be contrasted with run-time, which is the period of time when the CRGs and/or CIGs are being distributed and/or executed.

The authoring tools 554 are suitably the authoring tools 400 of FIG. 4, optionally, less the tools directed towards the generation and/or modification of CRGs. It is contemplated that the CRGs are localized and/or updated by one of the guideline publisher(s) and/or business entity(ies) 102, such as a business entity doing so as part of a paid service, whereby the tools directed towards CRGs would be unnecessary. Knowledge engineers use the authoring tools 554 to generate and/or modify CRGs and/or CIGs as described in connection with the authoring tools 400 of FIG. 4. It is contemplated that if the institution 500 receives an updated guideline, CRG or narrative from, for example, the national guideline publisher 102a of FIG. 1, the authoring tools 554 are employed to update the local CRGs and/or CIGs corresponding to the updated guideline.

The local CRGs are suitably stored in a CRG database 556 of the authoring environment 508, and the local CIGs are suitably stored in a CIG database 568 of the CDSS 510. However, in certain embodiments, the local CRGs are stored in a source external to the authoring environment 508 and/or the local CIGs are stored in a source external to the CDSS 110. For example, it is contemplated, that one of the guideline publisher(s) and/or business entity(ies) 102 maintains the local CRGs as part of a paid service. The CIG database 568 is suitably accessed via the communications network 504.

The clinical decision support system 510 acts as a centrally hosted execution environment for computer-interpretable guidelines (CIGs). Suitably, the clinical decision support system 510 receives and stores guidelines from one or more guideline publisher(s), such as the guideline publisher(s) and/or business entity(ies) 102 of FIG. 1. However, it is also contemplated that other components of the institution 500 perform this task. Further, the clinical decision support system 510 receives input from the clinical device(s) 502 and sends updates and/or recommendations to the clinical device(s) 502.

By way of overview, the clinical decision support system 510 receives messages including end user input and/or patient data input from one of more of the clinical devices 502 related to a specified patient with known conditions, diseases or treatment. These messages include one or more of instantiation messages, update messages, registration messages, and the like. Further, these messages include one or more of a patient ID, a device ID, a CIG ID, a CIG instance ID, and the like.

Instantiation messages cause the clinical decision support system 510 to create an instance of a CIG identified in the message. A CIG instance is the data that must be persisted to allow the execution of a particular CIG for a particular patient to continue when re-loaded. Typically, the instance is created for the combination of patient ID and device ID specified in the message. In certain embodiments, instantiation messages are not required and an instance of a CIG is established for a patient by other means (e.g., automatically when a patient is admitted to the institution 500). Instantiation messages typically cause the clinical decision support system 510 to register the source of the message for receipt of recommendations when an identified CIG instance is updated. Notably, registration messages require the existence of a CIG instance.

Update messages update an identified CIG instance. Assuming the identified CIG was previously instantiated by, for example, an instantiation message, the clinical decision support system 510 uses the CIG instance to restore its state, which reflects where the associated patient is in the care process.

After creating or restoring the instance of the CIG, the clinical decision support system 510 processes and evaluates data in the update message and updates the CIG instance on the basis of the result of the evaluation. Further, in certain embodiments, the clinical decision support system 510 initiates a monitoring process for detecting particular events or conditions (e.g., passage of time, lab test results, a physician order entry) and updates the CIG instance based on the monitored events and/or conditions.

After updating the CIG instance, the clinical decision support system 510 collects CIG recommendations for the updated CIG instance. The collected CIG recommendations are then communicated to one or more of the clinical device(s) 502. These devices typically requested registration on a prior occasion. In certain embodiments, the CDSS 510 notifies devices ‘working on’ a particular patient that there is a CIG instance associated with that patient, upon which such devices may decide to register for that instance. Alternatively, these devices searched for CIG instance IDs of interest on the communications network 504 by exchanging a discovery message containing, for example, a patient ID and a CIG ID with another component of the institution 500, such as the CDSS 510, to acquire and register for a corresponding and available CIG instance ID.

With reference to FIG. 6, a functional view of the clinical decision support system 510 is provided. The clinical decision support system 510 suitably includes the CIG database 568, an instance database 570, a server 574, and the like. However, other configurations are contemplated. For example, it is contemplated that the CIG database 568 is external to the CDSS 510. As another example, it is contemplated that the server 574 is embodied by a plurality of servers.

The CIG database 568 stores CIGs of the institution 500 indexed by, or associated with, a CIG ID. The CIGs are suitably generated and/or updated by the authoring tools 554. Additionally or alternatively, the local CIGs are generated and/or updated remotely by one or more guideline publisher(s), such as the guideline publisher(s) and/or business entity(ies) 102 of FIG. 1, and received by a component of the institution 500, such as the clinical decision support system 510, which stores the CIGs to the CIG database 568 directly or indirectly. As noted above, it is contemplated that the guideline publisher(s) and/or business entity(ies) 102 include business entities that provide CIG creation and/or management services.

The instance database 570 stores instances of the CIGs in the CIG database 568. Suitably, the instances are indexed by a unique CIG instance ID. Further, as noted above, the instances are suitably patient specific. As illustrated, the CIG instances are suitably maintained by the server 574. However, it is contemplated that other components of the institution 500 maintain the CIG instances.

The server 574 acts as a centrally hosted execution environment for computer-interpretable guidelines (CIGs) to assist clinicians. The server 574 includes one or more of a message router 576, an instantiation service 578, an instance service 580, and the like. It is to be appreciated that these functional components are merely abstractions to simplify the discussion hereafter and are not intended to be construed as limiting the structural layout of the CDSS 510. Further, it is contemplated that a plurality of the message router 576, the instantiation service 578, and the instance service 580 are combined. For example, it is contemplated that the instantiation service 578 and the instance service 580 are the same service.

The message router 576 receives messages containing end user input and/or patient data input from the clinical device 502 and/or other devices of the institution 500. These messages include one or more of instantiation messages, update messages, registration messages, and the like. Further, these messages include one or more of a patient ID, a device ID, such as an IP address, a CIG ID, a CIG instance ID patient data, and the like.

The message router 576 suitably determines whether to route messages to the instantiation service 578 or the instance service 580 on the basis of message type. For example, if a message is an instantiation message, the message is routed to the instantiation service 578. Otherwise, it is routed to the instance service 580. The type of message is suitably determined through consideration of corresponding CIG instance IDs and/or combinations of CIG IDs, device IDs, and patient IDs.

If a CIG instance ID is provided in a message, the message is typically one of an update message and a registration message, whereby it is routed to the instance service 580. If a message lacks a CIG instance ID or includes a reserved CIG instance ID associated with the instantiation service 578, but includes a combination of a patient ID, a device ID, and a CIG ID, the message is typically an instantiation message, whereby it is routed to the instantiation service 578.

The instantiation service 578 creates instances of CIGs on the basis of instantiation messages routed thereto from the message router 576. Upon receipt of a message, the instantiation service 578 looks up the CIG referred to by CIG ID in the CIG database 568. It then creates an instance of the CIG for a combination of a specified patient ID and a specified device ID. The CIG instance contains the logic for providing and recommending evidence-based care steps for the specified patient and clinical device. This instance of the CIG is maintained in a persistent state in the instance database 570 until all the care steps of the CIG are completed, its applicability is ended, it is manually deleted, or the like.

The instantiation service 578 suitably assigns the instance with a unique ID, which is provided to the clinical device generating the instantiation message in a return message. This corresponds to the so called CIG instance ID above. The clinical device (or any clinical device) can then send updates, such as patient data and/or end user input, to this ID to inform the clinical decision support system 510 about the current state of the CIG instance (e.g., last set of recommendations for specified patient) or register itself for keeping notified of recommendation messages.

The instance service 580 updates instances of CIGs on the basis of messages routed thereto from the message router 576. Upon receipt of a message, the instance service 580 determines how to process the message. The message is typically one of an update messages, a registration messages, and the like. An update message is sent by one of the clinical device(s) 502 to update an instance of a CIG. A registration message is sent by one of the clinical device(s) 502 to subscribe to an instance of a CIG so as to receive information pertaining to updates thereto. In certain embodiments, the message is a special service request message. A special service request message requests information on the recommendation structure (text, level of evidence, strength) or alarm structure (priority, time interval) of a CIG instance.

To the extent a message is determined to be an update message, the instance service 580 uses the identified CIG instance to restore its state, which reflects where the associated patient is in the care process. The current state is suitably restored from the instance database 570 through a lookup on the basis of a specified CIG instance ID and/or a combination of a specified patient ID, a specified device ID, and a specified CIG ID.

Once a CIG instance is restored, the instance service 580 evaluates patient data in the message using any logic associated with current state of the CIG instance and updates the state of the CIG instance accordingly. In certain embodiments, the instance service 580 further updates the CIG instance on the basis of whether one or more events on which the CIG instance depends have occurred. For example, in certain embodiments, the instance service 580 installs timers to monitor the passage of time, thereby allowing time based dependences to influence the CIG instance. Additionally or alternatively, in certain embodiments, the instance service 580 installs timers and/or monitors based on the present state of the CIG instance to prompt an update of a CIG instance. Additionally or alternatively, in certain embodiments, the instance service 580 further updates the CIG instance on the basis of patient conditions, as determined by patient data from one or more ones of the clinical device(s) 502 different than the clinical device generating the update message.

Once the CIG instance is updated, the instance service 580 collects recommendations generated as part of the updating process. The recommendations are suitably evidence-based and relevant to the latest status of the patient. After collecting recommendations, the instance service 580 then sends a recommendation message to one or more ones of the clinical device(s) 502 registered with the CIG instance. The recommendation message typically includes a structure with the set of recommendations and actions performed. In certain embodiments, the installed timers are employed to generate a recommendation message with an alert.

To the extent a message is determined to be a registration message, the instance service 580 associates the source of the registration message with the requested CIG instance in the instance database 570. The lookup is suitably performed as described in connection with an update message. The source is suitably one of the clinical device(s) 502. By registering the instance service 580 provides the source with any recommendation messages that are generated. In certain embodiments, registration messages and/or institution protocol impose limitations on when registered devices are notified. It is contemplated that these limitations are based on one or more of device location, user role, and the like. Further, it is also contemplated that certain devices are automatically registered on the basis of protocols of the institution 500, the care step within a CIG instance, and the like. Even more, it is also contemplated that devices ‘working on’ a particular patient associated with a CIG instance are notified of the CIG instance so they may register.

With reference to FIG. 7, a structural view of the clinical decision support system 510 is provided. A communications unit 582 of the server 574 facilitates communication between the server 574 and external devices, such as the clinical device(s) 502. In certain embodiments, the communications unit 582 employs a asynchronous communication protocol, such as SOAP, XML over HTTP/TCP/IP, and the like, for communicating with the clinical device(s) 502. The communications unit 582 further facilitates communication with the databases 568, 570, 572 of the clinical decision support system 510. A memory 584 of the server 574 stores executable instructions for performing one of more of the functions associated with the server 574. A controller 586 of the server 574 executes instructions stored on the memory 584 to carry out the functions associated with the server 574.

With reference to FIG. 8, a method 800 for centrally executing CIGs is provided. This method 800 is suitably performed by the clinical decision support system of FIG. 5. An update message from a first group of one or more clinical device(s) is received 802 over a communications network, where the update message includes patient data and identifies a CIG instance corresponding to a patient of the patient data. The CIG instance is updated 804 using the patient data and one or more CIG recommendations are determined 806 based on the updated CIG instance. The CIG recommendations are communicated 808 to a second group of one or more clinical devices over the communications network.

With reference to FIG. 9, a method 900 of electronically distributing clinical guidelines is provided. One of the institution(s) 106 of FIG. 1 suitably performs the method 900. However, it is also contemplated that one of the guideline publisher(s) and/or business entity(ies) 102 performs the method 900, such as a business entity distributing CRGs as a paid service.

A narrative guideline is received 902 from a guideline publisher over a communications network. The narrative guideline is transformed 904 to a computer represented guideline (CRG) abstractly representing the narrative guideline on the basis of usage. The translation 904 includes linking text fragments in the narrative guideline to instantiated language constructs. Additionally or alternatively, the translation 904 includes mapping 906 text fragments of the narrative guideline to one or more concepts in a medical ontology; identifying 908 one or more evidence-based care steps from the concepts; and consolidating 910 the care steps into a time-lined and/or structured sequence.

According to other aspects of the method 900, in certain embodiments, the CRG is transformed 912 to a computer interpretable guideline (CIG). The transformation 912 resolves localization constraints imposed on the CRG with location specific information. Additionally or alternatively, in certain embodiments, the CIG and/or the CRG are communicated 914 to a medical institution. Additionally or alternatively, in certain embodiments, an updated version of the narrative guideline is received 916 from the guideline publisher over the communications network and the CRG is updated 918 using the updated narrative guideline. Portions of the CRG in need of update are identified using links between the CRG and the narrative guideline.

Each of the databases described herein, such as the patient database 546 of FIG. 5 suitably include a computer database, where the computer database is embodied by a single computer, distributed across a plurality of computers, or the like. Further, each of the databases suitably stores data in a structured manner facilitating recall and access to such data. Further, as used herein, a memory includes one or more of a magnetic disk or other magnetic storage medium; a non-transient computer readable medium; an optical disk or other optical storage medium; a random access memory (RAM), read-only memory (ROM), or other electronic memory device or chip or set of operatively interconnected chips; an Internet server from which the stored instructions may be retrieved via the Internet or a local area network; or so forth. Further, as used herein, a controller includes one or more of a microprocessor, a microcontroller, a graphic processing unit (GPU), an application-specific integrated circuit (ASIC), a field-programmable gate array (FPGA), and the like; a communications network includes one or more of the Internet, a local area network, a wide area network, a wireless network, a wired network, a cellular network, a data bus, such as USB and I2C, and the like; a user input device includes one or more of a mouse, a keyboard, a touch screen display, one or more buttons, one or more switches, one or more toggles, and the like; and a display includes one or more of a LCD display, an LED display, a plasma display, a projection display, a touch screen display, and the like.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A system for centrally executing computer interpretable guidelines, said system comprising:
a first group of one or more clinical devices and a second group of one or more clinical devices;
a clinical decision support system that:
receives one or more update messages from the first group of clinical device(s) over a communications network, wherein the update message(s) include patient data and/or end user input and identify a CIG instance corresponding to a patient associated with the patient data;
updates the CIG instance using the patient data and/or end user input;
determines one or more CIG recommendations based on the updated CIG instance; and,
communicates the CIG recommendations to the second group of clinical device over the communications network.

2. The system according claim 1, further including:
a patient database containing an electronic medical record for the patient; and,
wherein the clinical decision support system updates the CIG instance on the basis of the electronic medical record.

3. A method for centrally executing computer interpretable guidelines (CIGs), said method comprising:
receiving one or more update message from a first group of one or more clinical devices over a communications network, wherein the update message(s) include patient data and/or end user input and identify a CIG instance corresponding to a patient associated with the patient data;
updating the CIG instance using the patient data and/or end user input;
determining one or more CIG recommendations based on the updated CIG instance; and,
communicating the CIG recommendations to a second group of one or more clinical devices over the communications network.

4. The method according to claim 3, further including:
determining whether one or more events on which the CIG instance depends have occurred; and,
updating the CIG instance on the basis of the determination.

5. The method according to claim 3, further including:
after the patient has become associated with a third group of one or more clinical devices different than the first group of clinical device, receiving patient data from the third group of clinical device over the communications; and,
updating the CIG instance on the basis of patient data from the third group of clinical device(s).

6. The method according to claim 3, further including:
receiving an instantiation message from the first group of clinical device(s) over the communications network, wherein the instantiation message identifies a CIG and the patient; and,
creating the CIG instance for the patient from the CIG.

7. The method according to claim 3, wherein the CIG instance includes a time-lined and structured sequence of evidence-based care steps, wherein updating the CIG instance changes a location within the sequence.

8. The method according to claim 3, further including:
receiving a computer represented guideline (CRG) from a remote guideline publisher and/or business entity, wherein the CRG includes abstraction based on usage; and,
generating a CIG from the CRG, wherein the CIG is generated from the CRG and localized, wherein the CIG instance is derived from the CIG.

9. The method according to claim 3, further including:
receiving a narrative guideline from a guideline publisher and/or business entity;
generating a computer represented guideline (CRG) from the narrative guideline, wherein the CRG includes abstraction based on usage; and,
generating a new CIG or an updated CIG from the CRG, wherein the CIG is generated from the CRG and localized, wherein the CIG instance is derived from the CIG.

10. The method according to claim 3, further including:
receiving a computer interpretable guideline (CIG) from a guideline publisher and/or business entity, wherein the CIG instance is derived from the CIG.

11. The method according to claim 3, further including:
receiving a narrative guideline from a guideline publisher and/or business entity over a communications network; and,
transforming the narrative guideline to a computer represented guideline (CRG) abstractly representing the narrative guideline on the basis of usage, wherein said translation includes linking text fragments in the narrative guideline to instantiated language constructs.

12. (canceled)

13. A method of electronically distributing clinical guidelines, said method comprising:
receiving a narrative guideline from a guideline publisher and/or business entity over a communications network); and,
transforming the narrative guideline to a computer represented guideline (CRG) abstractly representing the narrative guideline on the basis of usage, wherein said translation includes linking text fragments in the narrative guideline to instantiated language constructs.

14. (canceled)

15. The method according to claim 11, further including at least one of:
transforming the CRG to a computer interpretable guideline (CIG), wherein the transformation resolves localization constraints imposed on the CRG with location specific information;
communicating the CIG and/or the CRG to a medical institution over the communications network,
receiving an updated version of the narrative guideline from the guideline publisher over the communications network; and,
updating the CRG using the updated narrative guideline, wherein portions of the CRG in need of update identified using the links,
receiving (802) an update message from a first clinical device (502) over a second communications network (504), wherein the update message includes patient data and identifies a CIG instance;
updating (804) the CIG instance using the patient data;
determining (806) one or more CIG recommendations based on the updated CIG instance; and,
communicating (808) the CIG recommendations to a second clinical device (502) over the second communications network (504).

16. (canceled)

17. (canceled)

18. (canceled)

19. One or more processors preprogrammed to perform the method according to claim 3.

20. A non-transitory computer readable medium carrying software which controls one or more processors to perform the method according to claim 3.
